(19) United States
(12) Patent Application Publication
(10) Pub. No.: US 2024/0337837 A1
(43) Pub. Date: Oct. 10, 2024

(54) DYNAMIC COMPENSATION OF TRANSPARENT HEAD UP DISPLAY FOR HOLOGRAPHIC EFFECTS

(71) Applicant: Ford Global Technologies, LLC, Dearborn, MI (US)

(72) Inventors: John Robert Van Wiemeersch, Novi, MI (US); Janice Lisa Tardiff, Plymouth, MI (US); Haibo Zhao, Northville, MI (US); Ryan Joseph Gorski, Grosse Pointe Farms, MI (US)

(73) Assignee: Ford Global Technologies, LLC, Dearborn, MI (US)

(21) Appl. No.: 18/295,951

(22) Filed: Apr. 5, 2023

(51) Int. Cl. G02B 27/01; G02B 27/00; G02B 27/18

(52) U.S. Cl. CPC G02B 27/0103; G02B 27/0012; G02B 27/18; G02B 2027/0109; G02B 2027/011; G02B 2027/014; G02B 2027/0187

(57) ABSTRACT

The disclosure provides an apparatus and method for compensating a head up display (HUD) for holographic effects introduced by a hologram display screen. The hologram display screen is disposed in a glazing such as a window of a vehicle. The hologram display screen is illuminated by light projected by a projector. The light is modulated in accordance with an array of first pixel intensity values defining an image that conveys information to an operator of the vehicle. A first position within the eyebox is received from an eye tracking device. In response to receiving the first eyebox position, the projector is controlled to modulate the light projected by the projector to compensate images diffracted from the hologram into the eyebox based on eyebox position.

### BACKGROUND

A head up display (HUD) for a vehicle can comprise a projector that projects an image onto a hologram comprising a planar array of holographic optical elements (HOEs) disposed in a vehicle windshield to form an in plane (IP) transparent display (TD). HOEs are optical elements which themselves are holograms. Holograms are recordings that capture light intensity and phase of a wavefront of light reflected from an object and interfered by a reference light. The resulting light interference pattern is recorded on a light sensitive medium. When the hologram recording is played back by illuminating the material with a conjugate of the reference light, a 3D image of the object can be observed.

In one recording technique relevant to the disclosure, the ‘object’ is a conventional lens and the 3D image is an image of the conventional lens. A reference light wavefront is arranged to interfere with the light wavefront reflected from lens hologram. This produces a second light interference pattern which is recorded in a light sensitive recording medium. This second interference pattern is the HOE that is disposed in the vehicle windshield. A thick or volume hologram is one where the thickness of the recording medium is greater than the spacing of the fringes of the interference pattern. The recorded hologram is a three-dimensional structure. HOEs recorded in this fashion are referred to as Volume Holographic Optical Elements or VHOEs. In a thick hologram, light scatters into primarily one diffraction order.

In a HUD application, an optical image can be projected onto the HOE. The interference fringes diffract the incident optical image light in the same manner as a conventional diffraction optical element with the same optical transfer function would diffract the light. In other words, the hologram can be used instead of a conventional optical element.

The type of hologram referenced in the disclosure is used as a lens for its light directing functions. It also serves as a projection display screen for displaying projected optical images to convey information to a human observer. The hologram lens is a smaller, flatter and less bulky lens than its conventional counterpart. The holographic lens can be deployed where physical constraints make the conventional lens impractical. The holographic recording medium can be readily disposed in a vehicle, e.g., in a vehicle windshield or a vehicle window. The medium is transparent when illuminated by ambient light. This allows a vehicle occupant to observe the projected images while looking through the medium in the windshield.

As a lens, the hologram has many advantages as noted above. However, an HOE is a diffraction optical element (DOE) which, by design diffracts light at different wavelengths in different directions and with different intensity distributions. Thus, as a projection screen a HOE can introduce chromatic aberrations into a projected polychromatic optical image. In effect, the hologram screen produces different versions of the same projected optical image, each version having a unique intensity distribution pattern. Which version of a projected optical image an observer sees depends on where in space the observer intercepts the diffracted optical image.

In the context of a vehicle HUD display, a vehicle operator may see a different ‘version’ of a projected optical image when the operator changes their position, even though the optical image produced by the projector did not change.

### BRIEF DESCRIPTION OF THE DRAWINGS

FIG. 1 is pictorial diagram illustrating components of a head-up display;

FIG. 2 is a perspective diagram illustrating view angle with respect to a hologram screen and an eyebox;

FIG. 3 is a block diagram of an apparatus for compensation of holographic effects;

FIGS. 4A and 4B are diagrams illustrating example intensity distribution patterns;

FIG. 4C is a diagram of an example pixel array comprising an example digital image;

FIG. 4D is a diagram of an example correction array;

FIG. 5A is a flowchart of an example method for compensating a transparent display for holographic effects;

FIG. 5B is a flowchart of an example method for compensating a transparent display for holographic effects;

FIG. 6 is a flowchart of an example method for compensating a transparent display for holographic effects;

FIG. 7 is a flowchart of an example method for compensating a transparent display for holographic effects;

FIG. 8 is a flowchart of an example method for compensating a transparent display for holographic effects; and

FIG. 9 is a flowchart of an example method for compensating a transparent display for holographic effects.

### DESCRIPTION

A vehicle operator may not expect to see a different version of an image each time they change their position within an eyebox. In some cases, the differences in the versions may be negligible. In other cases, they may be distracting. The systems and methods disclosed herein compensate the HUD for the holographic effects of the hologram screen, by which different versions of the same projected image exist simultaneously at different points in the eyebox. These different versions exist without an observer present to observe them.

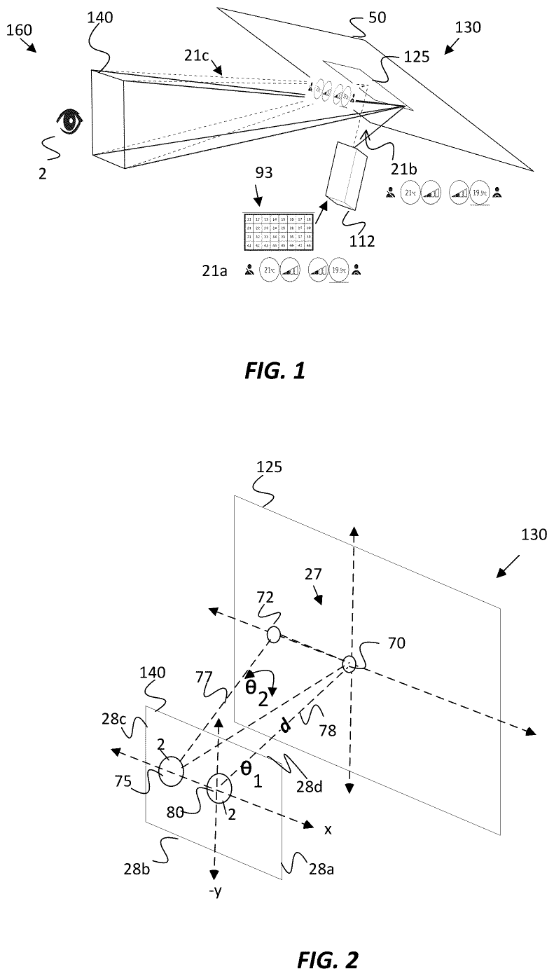

FIG. 1 is a block diagram of basic components of a Head up Display (HUD) 160. A projector 112 is arranged to project an optical image 21b comprising light modulated in intensity accordance with an array of pixels comprising digital image 93 and representing a source optical image 21a, onto a hologram 125 disposed in a vehicle glazing. e.g., windshield 50. Optical image 21b has an intensity distribution pattern defined by pixel values of digital image 93. Together, hologram 125 and vehicle windshield 50 form a transparent display (TD) 130 in which hologram 125 acts as a projection screen. Windshield 50 is but one example of a suitable transparent surface in which hologram 125 could be disposed. The disclosure is not intended to be limited to windshields as transparent surfaces for disposition of hologram 125. For example, hologram 125 could be disposed within other glazing or transparent surfaces such as a side window or a rear window of a vehicle. Any glazing of a vehicle can be suitable as a transparent surface in which to dispose hologram 125.

Hologram 125 diffracts the image-modulated light defining optical image 21b as a planar wavefront into a free space observation plane referred to as an eyebox 140. A user 2 whose eyes are positioned at any point within the area of eyebox 140 can perceive a diffracted optical image 21c as a diffracted version of optical image 21b unique to that position. The diffracted optical image 21c appears to user 2 to be floating in space in the plane of vehicle windshield 50. This kind of hologram is referred to as an in plane (IP) hologram because to an observer the image appears at the plane of the hologram, in this case at the plane of windshield 50. In other words, the image appears to be in the glass of windshield 50.

An IP hologram suitable for use with the examples disclosed herein can comprise a large hologram formed as an array of relatively smaller holograms. Each of the smaller holograms can be an individual HOE. These smaller hologram elements are also referred to herein as ‘hogels.’ This kind of hologram and holographic recording media therefor are commercially available from, e.g., Ceres Holographics, Ltd. of Saint Andrews, Scotland.

FIG. 2 is a perspective view of a hologram 125 of a TD display 130 and an eyebox 140 showing a relationship between positions within eyebox 140. Eyebox 140 is a space within which the pupil of an observer's (i.e., user 2) eye must be positioned in order to see the four edges (28a, 28b, 28c, 28d) of diffracted optical image 21c (diffracted from hologram 125 into eyebox 140). Positions on hologram 125 can be specified as coordinates in a two-dimensional plane defined by a surface of hologram 125. Likewise, points in space on a two-dimensional planar slice of eyebox 140 can be specified by coordinates in the framework of the planar slice of eyebox 140 parallel to the plane defined by the surface of hologram 125 and separated from the plane of hologram 125 by a distance d.

In some examples, the plane of hologram 125 corresponds to a plane of vehicle windshield 50. Given the hologram functions and the design specifications discussed above, coordinates in one coordinate system can be converted to coordinates in another.

Examples of design specifications include origin, point O of light from a digital light projector, distance from the origin point to the transparent holographic screen, seating positions of a vehicle occupant with respect to the transparent holographic screen. Other associated design parameters include a diffraction angle to direct light t the eyebox of a vehicle occupant Another design parameter is a specified tradeoff between eyebox size and luminance. A minimum eyebox size provides a highest luminance. On the other hand, the eyebox size may be maximized at the expense of luminance.

In the context of this disclosure the term ‘viewing angle’ refers to an angle formed between a first line that extends along an axis normal to the plane of hologram 125 from a point in the planar slice of eyebox 140 corresponding to the position of an observer (user 2) of hologram 125, to a point at which the line intercepts the hologram 125, and a second line that extends from the eyebox point of user 2 to a center point of hologram 125. A viewing angle of user 2 corresponds to a diffraction angle of hologram 125.

An eyebox center position 80 of a user 2, and a second position 75 of the user 2 are shown. To facilitate discussion, the example points discussed herein are assumed to be co-planar, i.e., the example points lie on the same x-y plane separated by the distance d from hologram 125. At eyebox center position 80, line 78 is normal to the plane of hologram 125. Line 78 extends from eyebox center position 80, which is at the center of the eyebox, to intercept hologram 125 at a point corresponding to center 70, which is at the center of hologram 125. Because the first observer position is at eyebox center position 80, and line 78 intercepts the screen at the center 70, a second line that extends from user 2 to the center of the screen is the same line. This defines a first viewing angle θ₁ of 0°.

At a point corresponding to position 75, a first line 77 extends normal to the plane of hologram 125 from position 75 of user 2 to intercept hologram 125 at a point 72. A second line extending from position 75 to center 70 of hologram 125 defines a second non-zero viewing angle θ₂. As described in further detail below, specifications for hologram 125 include a specified eyebox size, specified dimensions of hologram 125 and a specified distance between eyebox 140 and hologram 125. Given values for these parameters, a viewing angle can be computed for any given observer position on eyebox 140. Likewise, for any given position in eyebox 140, a corresponding position on hologram 125 can be determined and vice versa.

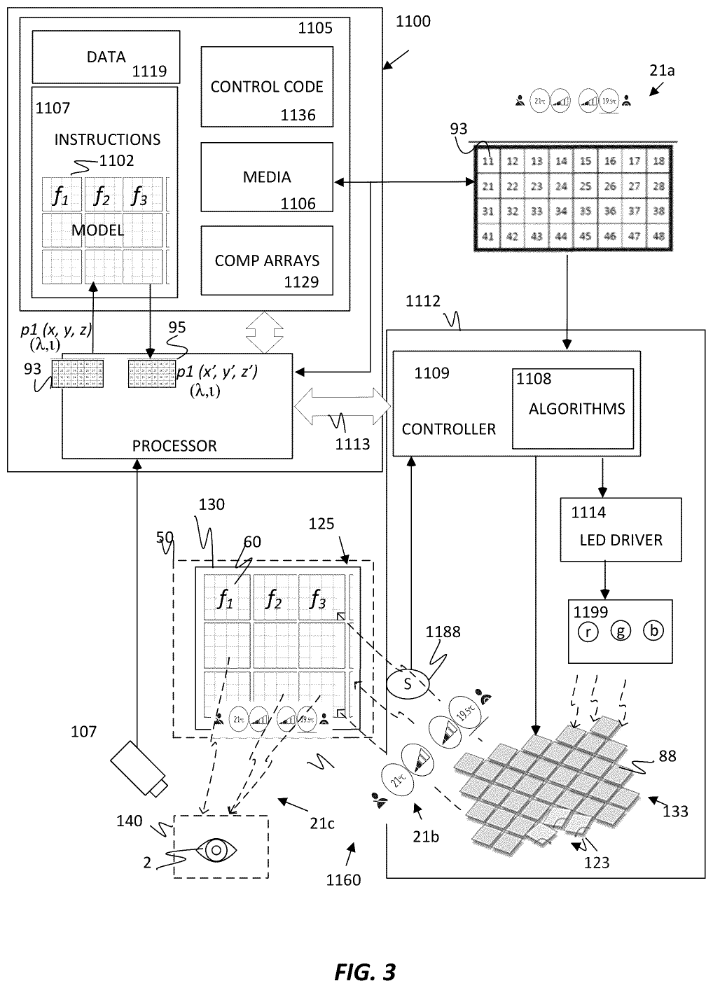

FIG. 3 is a block diagram of an apparatus 1100 for compensating an example HUD 1160 for holographic effects. HUD 1160 comprises a projector 1112 and a transparent display (TD) 130. TD 130 includes a transparent holographic film (not visible) in which an HOE is embodied as hologram 125. In the example of FIG. 3, the holographic film is disposed in a portion of a windshield 50 of a vehicle. Together, transparent holographic film, hologram 125 and the corresponding portion of windshield 50 form TD 130.

An optical image 21a is represented digitally as an array of pixel intensity values comprising digital image 93. Each pixel in the array may be defined by coordinates in the array and a pixel intensity value, which may be respective pixel intensity values for light at red, green and blue wavelengths. Other color representation schemes may be used to represent pixel color. Digital image 93 can comprise a frame of pixel values representing a video frame, one or more graphical symbols comprising an image provided from an external source, or a digital image stored in media storage 1106 of memory 1105, or any combination thereof.

The relative intensity values for each pixel define a mixture of red, green and blue colors that correspond to a color in some color space. For example, The CIE 1931 color spaces define quantitative links between distributions of wavelengths in the electromagnetic visible spectrum, and physiologically perceived colors in human color vision.

Luminance (brightness) and chromaticity (color) of objects in an image are interrelated. For example, in some implementations each pixel in digital image 93 can have a value that represents a weighted sum of light intensity at different wavelengths, e.g., red, green, and blue primary components, i.e., tristimulus components. Increasing the luminance in any of the red, green or blue channels can change the color and/or the brightness of the corresponding pixel. In some instances, each pixel of digital image 93 can be specified by three intensity values, one for red, one for green and one for blue.

Brightness and color are perceptual responses to luminance and chromaticity stimulus of light diffracted by hogels 60 of hologram 125. While not directly proportional, various techniques for conversion from luminance and chromaticity values to brightness and color values, and vice versa, including gamma corrections will be appreciated. Any of these techniques may be applied to arrive at compensation arrays suitable for further compensating projected images in accordance with the disclosure.

A controller 1109 of projector 1112 controls an LED driver 1114 to modulate intensities of light emitted by red, green and blue light emitting diodes (LED) comprising light source 1199 in accordance with the pixel intensity values in digital image 93. The intensity-modulated light emitted by light source 1199 illuminates an array 123 of spatial light modulators comprising micromirrors (one micromirror shown at 88) of a digital micromirror device (DMD) 133. Controller 1109 controls individual micromirrors, e.g., 88 to spatially modulate the intensity modulated light emitted by light source 1199 in accordance with pixel positions and intensity values of digital image 93. The intensity and spatially modulated light (hereinafter ‘image-modulated light’) defines an optical image 21b that is projected onto hologram 125 of TD 130, which serves as a display screen.

In some implementations controller 1109 includes a variety of control algorithms including color control algorithms for adjusting color and/or intensity of pixels comprising projected optical image 21b. Processor 1110 can control projector 1112 by providing instructions to controller 1109 to adjust one or more of the color control algorithms including adjusting gain settings of the color control algorithms.

In some implementations, projector 1112 comprises a Texas Instruments digital light processor DLP™ Pico™ chipset that includes controller 1109, DMD 133 and a power management Integrated Circuit (PMIC) (not depicted). For example, controller 1109 can comprise DLPC343× or similar display controller. In that case processor 1110 can communicate with controller 1109 via, e.g., an I²C interface 1113 including a serial data bus (not depicted). Instruction memory 1107 can include processor executable instructions that configure processor 1110 to configure controller 1109 to adjust optical image 21b in accordance with the methods described herein, including adjusting gain settings. Examples of commands for configuring controller 1109, including illumination control commands for controlling LEDs of light source 1199 can be found in ‘DLPC3430, DLPC3432, DLPC3433, DLPC3435 and DLPC3438 Programmer's Guide’ Texas Instruments Literature number DLP020D, July 2014-Revised April 2020, incorporated by reference herein in its entirety.

In some implementations projector controller 1109 includes a suite of image processing algorithms 1108 including, e.g., a local area brightness boost (LABB) algorithm and a content adaptive illumination control (CAIC) algorithm. In those implementations processor 1110 is configured to send software commands to projector controller 1109 via I2C interface 1113 to control the LABB algorithm to adaptively enhance (gain up) selected regions of optical image 21b in response to processor 1110 executing the methods disclosed herein. The LABB algorithm and its commands are described, e.g., in TI DLP™ IntelliBright™ Algorithms for the DLPC343× Controller, Application Report DLPA058-February 2015 hereby incorporated by reference in its entirety.

A source optical image 21a corresponding to projected optical image 21b can be represented in a memory as a digital image 93 comprising an array of picture elements (pixels). Colors of elements of optical image 21a can be digitally represented in terms of a red, a green and a blue intensity value associated with corresponding pixels of the pixel array comprising digital image 93. As noted above, array 123 of micromirrors 88 spatially modulates the intensity-modulated light emitted by light source 1199 in accordance with the pixel coordinates and pixel values of digital image 93.

Controller 1109 further controls micromirrors of micromirror array 123 in cooperation with LED driver 1114 in accordance with pixel values of digital image 93 to reconstruct optical image 21a on micromirror array 123 in one or more channels as noted above. Micromirror array 123 is arranged to project the light modulated in accordance with digital image 93 onto hogels 60 of hologram 125.

For purposes of this specification, a sub-pixel is a pixel represented solely in terms of one of its colors. In some implementations, micromirror array 123 is operated in conjunction with light source 1199 to reflect light in three, time-sequential sub-arrays, e.g., once for red sub-pixels, once for green sub-pixels and once for blue sub-pixels. Projector 1112 can further include one or more optical components (not shown) in the optical path between light source 1199, micromirror array 123 and TD 130. Accordingly, projector 1112 is a spatial light modulation (SLM) projector, which can be a DLP® projector.

Each hogel 60 of hologram 125 is illuminated by the modulated light from one or more micromirrors of array 123. Each hogel 60 can map to one or more pixels of digital image 93, which in turn can map to one or more micromirrors 88 of array 123. Each hogel 60 diffracts the image-modulated light into eyebox 140 in accordance with its particular optical prescription and application specifications. Each hogel's optical diffraction characteristics are defined by its interference pattern. The result of projecting the image modulated light onto the hogels is a light wave diffracted from the hogels, and varying in intensity over a space, such that intensity at any given position in space depends on angle of diffraction, diffraction efficiency and other parameters.

Controller 1109 can include one or more algorithms 1108 for management and control of color and other characteristics of projector 1112. These algorithms can be modified via software programmable features of controller 1109. For example, controller 1109 may execute a real-time color management algorithm that interacts with LED driver 1114 for LED current correction and updating color-related registers based on color targets and feedback from a sensor 1188 in the path between micromirror array 123 and hologram (screen) 125 to sense and measure projected light characteristics. Controller 1109 can adjust pixel values of the projected image accordingly. However, sensor 1188 is not arranged to sense light in the path between hologram 125 and user 2. Thus algorithms 1108 do not have a hogel light sensing mechanism and cannot correct non uniformities in intensity distributions from one observation position of user 2 to another with respect to hologram 125.

An apparatus 1100 according to the disclosure comprises a processor 1110 coupled to a memory 1105. Processor 1110 is configured by processor executable instructions stored in instruction memory 1107 to control projector 1112 in accordance with the methods and processes described and illustrated herein. Instruction memory 1107 also stores processor executable instructions that configure processor 1110 to perform the functions and methods disclosed and described herein and to implement a hologram model 1102 of hologram 125.

Memory 1105 can include instruction memory 1107, media storage 1106, data memory 1119 and control code memory 1136. Instruction memory 1107 includes processor-executable instructions that configure processor 1110 to perform the methods and processes described herein. Media storage 1106 can store digital images, such as digital image 93 of optical image 21a, in any form including graphical symbols and other media formats to be displayed by TD 130. Data memory 1119 can store hologram specifications as described herein and vehicle specifications including specifications for vehicle windshield 50. Data memory 1119 can store data for hologram model 1102 and other data including specifications, optical characteristics, parameter values such as luminance values, color transforms, gamma corrections, and other data which in some instances may be stored in databases, look up tables (LUT) or other data structures comprising memory 1105. Media storage 1106 can store media, e.g., sets of graphical symbols, icons, images and the like, comprising images to be projected by projector 1112 for viewing by a user 2 via HUD 1160. Memory 1129 can store compensation arrays, i.e., arrays of offset values for adjusting image modulated light defining optical image 21b. Instruction memory 1107, data memory 1119 or any other memory comprising memory 1105, can be implemented as integrated memory structures, or can comprise a plurality of separate memory structures. In some implementations, processor 1110, and memory 1105 or any of memories, 1106, 1107, 1136, 1129, and 1119 comprising memory 1105, can be integrated as a single structure, e.g., a System on a Chip (SoC).

Processor 1110 controls projector 1112 by sending projector or controller executable commands stored in control code memory 1136 to controller 1109 of projector 1112. When controller 1109 executes the commands, projector 1112 controls LEDs of light source 1199 and micromirrors of array 123 to adjust intensity values specified by pixels of digital image 93 in accordance with intensity adjustment values determined by processor 1110. In some implementations, commands transmitted to controller 1109 instruct controller 1109 to directly set parameters of LED driver 1114 and/or micromirrors of array 123 to adjust projected pixel values in accordance with adjustment values determined by processor 1110. In other implementations, commands transmitted to controller 1109 modify one or more algorithms 1108, look up tables, color models and the like, by which controller 1109 controls LED driver 1114 and micromirror array 123. All of these approaches are intended to remain within the scope of the disclosure.

A head or eye position sensor 107 is disposed in the vehicle and arranged to track a position of the head and/or eyes of user 2. In some implementations head or eye position sensor 107 can track a passenger head or eye position, a vehicle operator head or eye position, or both. Accordingly, in some implementations user 2 may be a passenger. Position provided by sensor 107 to processor 1110 can be specified in any coordinate system, e.g., a coordinate system of sensor 107, vehicle windshield 50, eyebox 140 or any other coordinate system. In one example implementation, sensor 107 can specify a head position as pixel coordinates on hologram 125. These coordinates have corresponding coordinates as a position in eyebox 140 in accordance with specified geometry of hologram 125, projector 1112 and TD130.

Geometry of eyebox 140 with respect to hologram 125 on vehicle windshield 50 is given by optical specifications of hologram 125, angle and curvature of vehicle windshield 50 and the position and pose of projector 1112 with respect to hologram 125. In some implementations hologram 125 can be calibrated during development before final disposition within vehicle windshield 50 to account for these factors in a specific vehicle or vehicle model. In that case, calibration data gathered from the procedures used for the calibration can be stored in data memory 1119, e.g., as a library of adjustments to model 1102, and/or adjustments to the executable instructions implementing hologram model 1102 to incorporate the calibration data into model 1102. Also, alignment of projector 1112 with hologram 125 in the windshield can be initially calibrated. This alignment can be re-calibrated periodically during scheduled maintenance of the vehicle. In both cases hologram model 1102 can be adjusted in accordance with the calibration.

Sensor 107 measures the position of the head of user 2 in a coordinate system, which can be reported by sensor 107 as a position on hologram 125 in the coordinate system 1 of hologram 125. The position can be specified as a point on eyebox 140 or as a point on hologram 125, or in any other suitable manner. Thus, a position reported in one coordinate system can be converted by processor 1110 to a corresponding position in another coordinate system. In an example implementation, coordinate system of model 1102 corresponds to coordinate system of hologram 125, as adjusted by any calibration data. In some implementations, processor 1110 may provide digital image 93 defining optical image 21b to model 1102. Processor 1110 also provides a head or eye position p (x, y, z) to model 1102. The head or eye position may be expressed in the coordinate system of hologram 125 which may be an adjusted coordinate system, or in any other suitable coordinate system.

In response, model 1102 can, as a proxy for hologram 125, provide an array of predicted pixel intensity values as digital image 95 wherein each pixel provides an array position and predicted light intensity values (i) for red, green and blue wavelengths (k) at that array position. The predicted values in the array of values comprising digital image 95 define a light intensity distribution pattern (and thus a color and brightness distribution pattern) for optical image 21c as diffracted into eyebox 140 with respect to the sensed head or eye position received from sensor 107.

In lieu of a light sensor disposed in the vehicle to measure light across a diffracted optical image 21c with respect to the eyebox position received from sensor 107, processor 1110 uses the predicted values of digital image 95 provided by hologram model 1102 at the reported head or eye position as proxy intensity measurement values. Based on the ‘proxy’ intensity measurement values, processor 1110 adjusts optical image 21b so that when optical image 21b is projected onto hologram 125, the adjusted values will compensate diffracted optical image 21c for the position-dependent intensity response of hologram 125 at the position received from sensor 107.

Processor 1110 can derive adjustment values by which to adjust optical image 21b in a variety of ways.

For example, in one implementation processor 1110 provides to model 1102, digital image 93 and a received eyebox position of user 2, e.g., a position received from sensor 107. In response, model 1102 can provide a first array of predicted intensity values corresponding to the received eyebox position, e.g., as an output digital image 95. Processor 1110 can also provide, for the same input digital image 93, a reference eyebox position. The reference eyebox position can be any eyebox position to be used as a basis for compensation of diffracted optical image 21c. For example, the reference eyebox position can be a center eyebox position. In that case, in response to receiving the reference eyebox position, model 1102 can provide a reference array of predicted intensity values in the form of a reference digital image 95. The reference array defines a predicted light intensity distribution pattern for diffracted optical image 21c with respect to the reference (center) eyebox position. Based on differences in the intensity values in the first array and the reference array, processor 1110 can generate a correction array, i.e., an array of intensity correction values. The correction array can be stored or buffered as a compensation array in memory 1129.

Processor 1110 can control projector 1112 in accordance with the correction array to adjust the modulation of light defining optical image 21b so as to provide an adjusted optical image 21b. When adjusted optical image 21b is projected onto hologram 125 the diffracted optical image 21c with respect to the eye position received from sensor 107, will have an intensity distribution pattern that matches the intensity distribution pattern of the reference position. In other implementations, instead of providing a correction array that produces an intensity distribution pattern that matches a reference, processor 1110 can provide correction arrays that have other relationships to a reference array. For example, processor 1110 can provide a correction array that produces a diffracted image having an average intensity at the received eyebox position, that is the same as the average intensity of the diffracted image at the reference position.

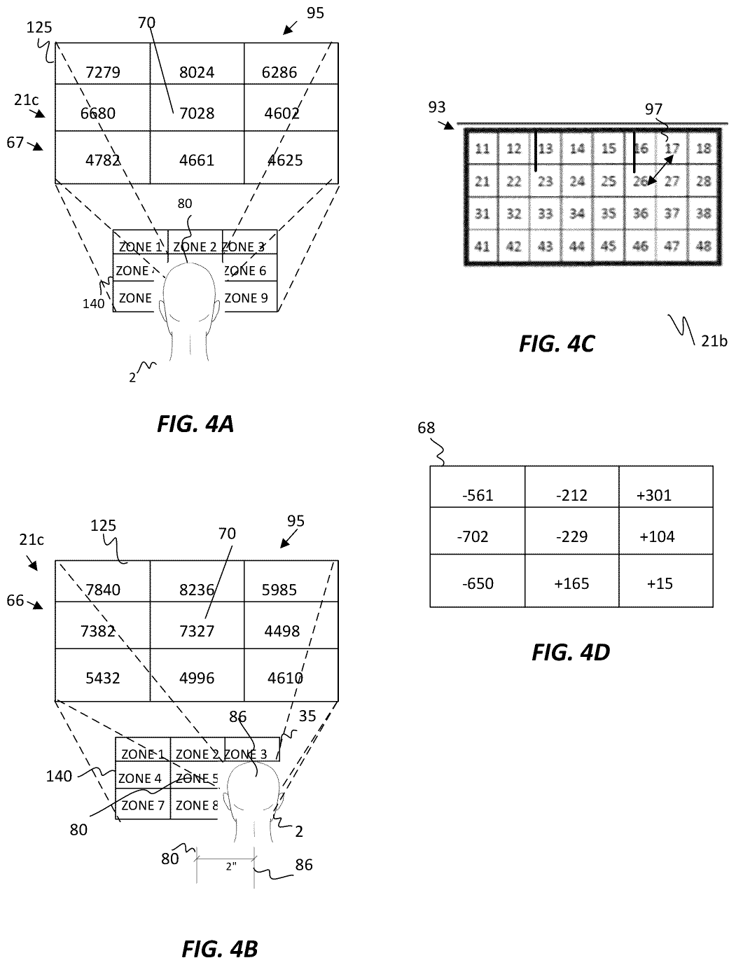

FIGS. 4A and 4B are diagrams illustrating light intensity distribution patterns for the same projected optical image 21b (represented as digital image 93 in FIG. 4C) as diffracted into eyebox 140 as a function of eyebox position. FIG. 4A shows an example 3×3 array 67 of cells or ‘spatial zones’ of a diffracted optical image 21c. Respective spatial zones contain corresponding respective light intensity (or luminance) measurement values. In this example the value in a spatial zone represents an average intensity over the spatial zone. A user 2 is shown to be observing diffracted optical image 21c via eyebox 140 from an eyebox center position 80, which corresponds to center 70 of hologram 125. With respect to eyebox center position 80 of eyebox 140 the image-modulated light defining projected optical image 21b, as diffracted from hologram 125 into eyebox 140, conveys diffracted optical image 21c as a first version of projected optical image 21b. The first version is defined by a first intensity distribution pattern demonstrated by the relative intensity values in each spatial zone of array 67.

FIG. 4B shows user 2 positioned with their head in an off-center eyebox position 86 within eyebox 140. At off-center eyebox position 86 the image-modulated light defining projected optical image 21b is diffracted from hologram 125 to convey optical image 21c. The second version is defined by a second intensity distribution pattern demonstrated by the relative intensity values in each spatial zone of array 66.

The example intensity values and array sizes shown in the FIGS. 4A and 4B are examples only. These are selected to demonstrate the non-uniform intensity distribution effects in a way that facilitates description of the effects. The example values, and their distribution patterns are not actual measured values. These values are not intended as limitations.

FIG. 4D shows an example correction array 68. For example, in a case where user 2 is observing diffracted optical image 21c from position 86 (FIG. 4B), sensor 107 detects eyes or head of user 2 at position 86. Processor 1110 can receive position 86 from sensor 107. Processor 1110 can provide digital image 93 (corresponding to diffracted optical image 21c) to model 1102 along with received eyebox position 86. In response, model 1102 can provide a digital image 95 (not depicted) comprising an array 66 of predicted, or ‘proxy’ intensity values for diffracted optical image 21c as observed from position 86. For input digital image 93, processor 1110 can provide eyebox center position 80 as a reference position to model 1102. In response, model 1102 can provide an array 67 of predicted (proxy) light intensity values for diffracted optical image 21c as would be observed from the reference position, i.e., from eyebox center position 80.

Processor 1110 can compare the values comprising array 66 to the values comprising array 67 to provide an array 68 of correction values based on the results of the comparison. In the example of FIG. 4D, correction array 68 is a difference array, i.e., the zone values of array 68 are differences between values in corresponding zones of array 66 and array 67. Correction array 68 can be stored or buffered in a memory. Processor 1110 can adjust optical image 21b in accordance with correction values in an array 68 to provide an adjusted optical image 21b. When adjusted optical image 21b is projected onto hologram 125, optical image 21c as diffracted with respect to position 86 has an intensity distribution pattern that matches the intensity distribution of optical image 21c as diffracted with respect to eyebox center position 80.

The disclosure is not limited to correction arrays based on difference values. Upon reading this disclosure, a wide range of correction arrays can be devised to achieve a wide range of desired intensity distribution patterns in diffracted optical images will be appreciated.

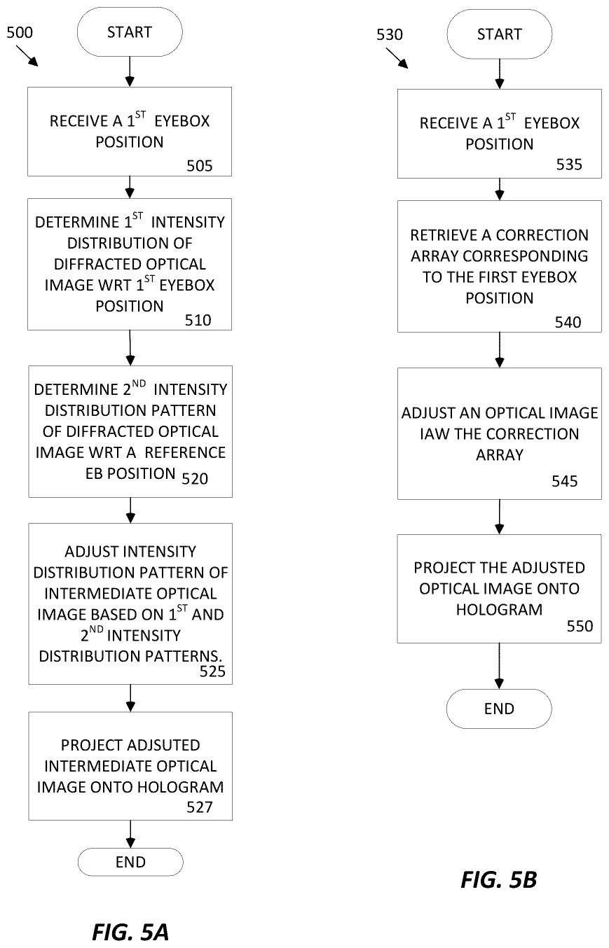

FIG. 5A is a flowchart of a method 500 for compensating a transparent display for holographic effects according to the disclosure. At block 505 an eye or head position (referred to herein as eyebox position) of a user 2 is received from an eye (or head) tracking device, e.g., sensor 107. User 2 can be, e.g., an operator of the vehicle who observes a diffracted optical image on hologram 125 from within eyebox 140 to obtain useful information from a displayed image. An eyebox position can be expressed as a point on hologram 125 at which a line extending from the eye of the observer to hologram 125 normal to a surface defining a viewing plane of hologram 125, intercepts hologram 125.

A received eyebox position can be expressed as a position of the observer's head with respect to hologram 125, or with respect to vehicle windshield 50, or referenced to another coordinate system. In example embodiments, sensor 107 is calibrated to hologram 125 and configured to report an eye or head position as coordinates that specify a point, or a zone on a surface of hologram 125 as defined above. The method can include calibrating sensor 107 to report eye or head position in any suitable coordinate system. The method can include converting an eye position reported in a first coordinate system to a corresponding point or region on hologram 125, or to a corresponding point or zone within eyebox 140.

At block 510 the method determines a first intensity distribution pattern of an optical image 21c conveyed by image-modulated light diffracted by hologram 125 into eyebox 140 with respect to the received eyebox position. In one example implementation, processor 1110 can use model 1102 to calculate the first intensity distribution pattern. In another example implementation, processor 1110 can use model 1102 to calculate an array of pixel intensity values defining diffracted optical image 21c in terms of intensity per wavelength (color) per pixel based on the received eye position and received digital image 93.

At block 520 the method determines a second intensity distribution pattern of optical image 21c conveyed by the image-modulated light diffracted into eyebox 140 with respect to a reference eyebox position, e.g., a center eyebox position. In another example implementation, processor 1110 can use model 1102 to calculate an array of pixel values defining diffracted optical image 21c with respect to a reference eyebox position in terms of intensity per wavelength (color) per pixel.

At block 525 the method adjusts an intensity distribution pattern of an optical image 21b so that adjusted optical image 21b, when projected onto hologram 125 and diffracted as optical image 21c into eyebox 140, will have a light intensity distribution pattern that matches the light intensity distribution pattern that would be produced with respect to the center eyebox position, by diffracting un-adjusted optical image 21b into eyebox 140.

At block 527, adjusted optical image 21b is projected onto hologram 125.

In practice an optimal intensity distribution of diffracted optical image 21c may be observed from the eyebox center position of eyebox 140. Light diffracted by the interference pattern of hologram 125 into eyebox 140 may be distributed about an intensity peak at a center of hologram 125, which corresponds to the center of eyebox 140. The diffracted optical image 21c may decrease in intensity, although non-linearly, away from the center of hologram 125.

As a result of performing method 500, optical image 21c conveyed by the image-modulated light diffracted to eyebox 140 at the position of user 2, will have an intensity distribution pattern that substantially matches the intensity distribution of optical image 21c conveyed by the image-modulated light at the center of eyebox 140-before adjustment of image 21b. In this context ‘substantially the same’ and ‘match’ means sufficiently similar to meet any applicable regulatory requirements. Substantially the same and ‘match’ can also mean sufficiently similar so that an average observer such as user 2, would not experience discomfort due to any residual change in intensity distribution from eyebox position to the next.

FIG. 5B is a flowchart of a method 530 for compensating a transparent display for holographic effects. At block 535 a first eyebox position is received, e.g., from eye or head position sensor 107. At block 540 a digital correction array corresponding to the first eyebox position is retrieved from a memory. In some implementations, intensity values comprising the digital correction array are computed in advance, e.g., by a calibration procedure. In some implementations a calibration procedure uses model 1102 to compute the values for the digital correction array.

At block 545 the method adjusts an optical image 21b based on the corresponding digital correction array. In one implementation, optical image 21b corresponds to digital image 93. The method adjusts optical image 21b by adjusting the intensity values of digital image 93 in accordance with the correction array.

At block 550 adjusted optical image 21b is projected onto hologram 125. When hologram 125 diffracts adjusted optical image 21b into eyebox 140, the diffracted optical image 21c has an intensity distribution pattern with respect to the first eyebox position, that matches an intensity distribution that optical image 21c would have if diffracted to a predetermined reference eyebox position without correction of optical image 21b. For example, a predetermined reference eyebox position can be a center eyebox position.

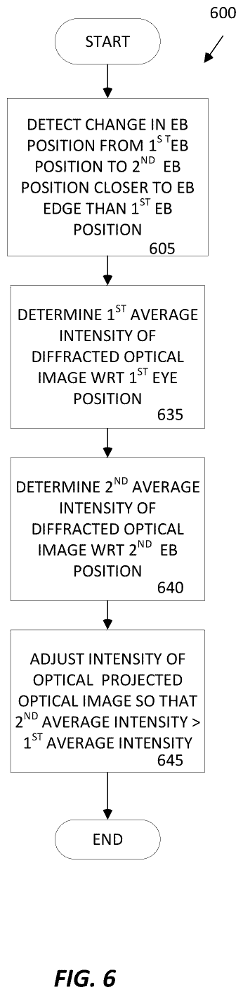

FIG. 6 is a flowchart of a method 600 for compensating transparent display TD 130 for holographic effects of hologram 125. At block 605 change in eyebox position from a first eyebox position to a second eyebox position is detected wherein the second eyebox position is closer to an eyebox edge position than the first eyebox position.

At block 635 the method determines a first average intensity of a diffracted optical image 21c with respect to the first eyebox position.

At block 640, the method determines a second average intensity of diffracted optical image 21c with respect to the second eyebox position.

At block 645 the method adjusts optical image 21b so that the first average intensity is the same as the second average intensity. In that manner diffracted optical image 21c conveyed by the image-modulated light with respect to a current position of user 2 is at least as bright as diffracted optical image 21c with respect to the last position of user 2.

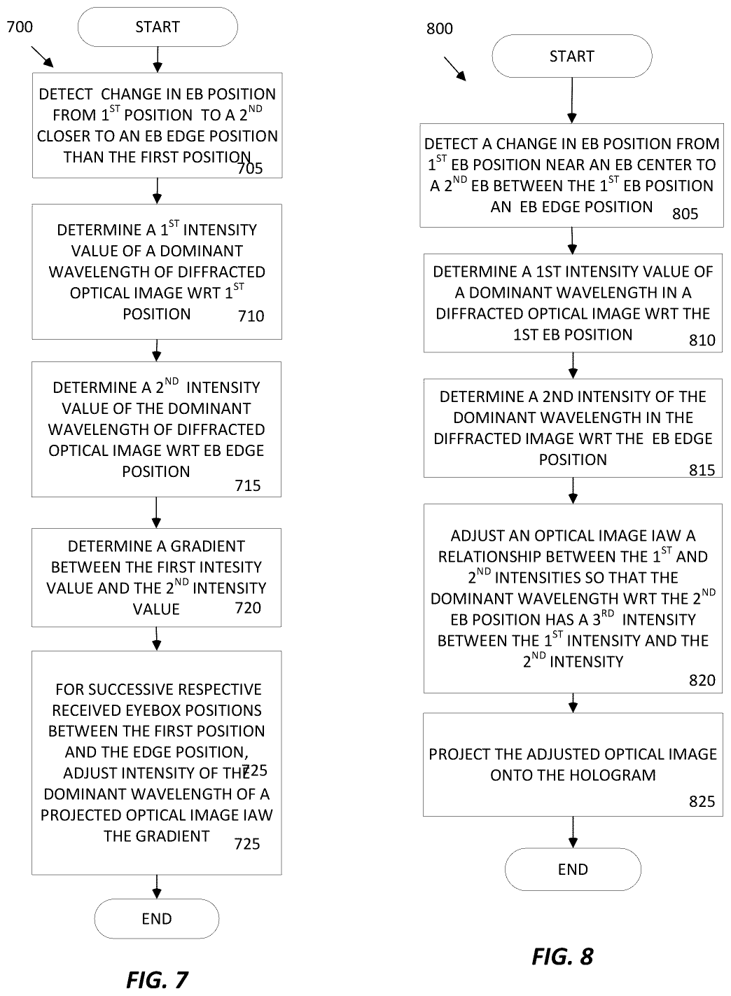

FIG. 7 is a flowchart of a method 700 for compensating a transparent display for holographic screen effects according to the disclosure. At block 705 a change in eyebox position of a user 2 from a first eyebox position to a second eyebox position within eyebox 140 is detected, wherein the second eyebox position is closer to an eyebox edge position than the first eyebox position.

At block 710 a first intensity value of a dominant wavelength in optical image 21c conveyed by the image-modulated light diffracted from hologram 125 with respect to the first eyebox position is determined. At block 715 a second intensity value of the dominant wavelength in optical image 21c conveyed by the image-modulated light diffracted from hologram 125 with respect to the second position is determined. At block 720 an intensity gradient is determined based on the 1^{st} and 2^{nd} values.

At block 725 for each successive, respective eyebox position received from sensor 107 the intensity of the dominant wavelength in diffracted optical image 21b is adjusted in accordance with the gradient so that intensity of the dominant wavelength in diffracted optical image 21c from one position to the next is gradual as eyes or head of user 2 move toward the eyebox edge position.

FIG. 8 is a flowchart of a method 800 for compensating a display for holographic effects according to the disclosure. At block 805 a change in eyebox position is detected from a first eyebox position within eyebox 140 to a second eyebox position within eyebox 140.

At block 810 the method determines a first intensity value of a dominant wavelength in a diffracted optical image with respect to the first eyebox position. At block 815 the method determines a second intensity of the dominant wavelength in the diffracted optical image with respect to the second eyebox position.

At block 820 optical image 21b is adjusted in accordance with a relationship between the first and second intensity values so that the dominant wavelength with respect to the second eyebox position has a third intensity value that is between the first intensity value and the second intensity value.

At block 825 the method projects the adjusted optical image 21b onto hologram 125.

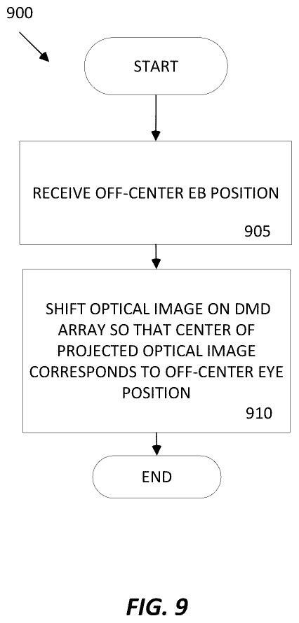

FIG. 9 is a flowchart of a method 900 for compensating a display for holographic effects according to the disclosure. At block 905 an off-center eyebox position is received. At block 910 the method shifts the projected optical image 21b with respect to digital micromirrors 123 so that the center of the corresponding diffracted optical image 21c corresponds to the received off-center eyebox position of corresponding to the center of eyebox 140.

As discussed above, hologram 125 can be modeled by its characteristic features. For example, optical ‘prescriptions’ or optical transfer functions f for holographic optical elements, or hogels, comprising hologram 125 are characteristic features. Hologram specifications upon which to model hologram 125 include specified values for fundamental grating design parameters such as wavelength range of use, diffraction efficiency, configuration with respect to incident beams, grating pitch and profile, diffracted wavefront, substrate size, shape and material, incident beam polarization state, output orders of interest, stray light, and other application specific parameters such as environmental requirements and grating geometry.

In addition, hologram 125 can be constructed in accordance with specified values for dimensions of the holographic film; eyebox size; an origin point ‘O’ of the projector that will be used for playback; a location and/or slope of a glazing such as windshield 50; divergence of the spatially modulated light produced by projector 1112; a range of acceptable locations of eyebox 140 with respect to seating positions in the vehicle; common ranges of operator height; operator position(s), and a minimum luminance for projector 1112.

A particularly salient feature of hologram 125 is its diffraction efficiency (η). Diffraction efficiency of a hologram lens is defined as the ratio of the intensity values of the diffracted wavefront, e.g., expressed as an array of hogel intensity values, to the intensity of the incident wavefront, e.g., the pixel intensity values of digital image 93. The diffraction efficiency of a specific diffraction order provides information of the efficiency of the hologram in deflecting light in a particular direction. Therefore, given the diffraction efficiency of a specific diffraction order, and intensity values of pixels of digital image 93, the intensity of the image modulated light diffracted from hologram 125 in a particular direction can be determined by model 1102.

Model 1102 may also specify hogels (lenses) by other optical functions, e.g., by a point-spread function, or impulse response function, which describe how a hogel's light ray emissions are distributed in all directions including the principal direction as defined by a grating structure. For example, an array of hogel intensity values on the hologram 125 plane can be modeled by superimposing point spread functions (PSFs) of the hologram's hogels.

In some example implementations, hologram 125 can be modeled using commercially available software for modeling holograms, e.g., ‘OpticStudio’ by Zemax LLC, of Kirkland, Washington.

Computer-executable instructions that configure processor 1110 to perform the functions and methods disclosed herein are machine code instructions. These may be provided based on computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium includes any medium that participates in providing data (e.g., instructions), which may be read by a computer. Such a medium may take many forms, including, but not limited to, non-transitory computer readable media (NTCRM), non-volatile media, volatile media, etc. Non-volatile media include, for example, optical or magnetic disks and other persistent, non-transitory memory. Volatile media include dynamic random-access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. An apparatus comprising:
a processor;
a memory coupled to the processor and storing processor-executable instructions that configure the processor to:
receive from an eye position sensor a first eyebox position within an eyebox defined by a hologram disposed in a window of a vehicle and illuminated by an optical image projected onto the hologram with a projected intensity distribution pattern;
in response to receiving the first eyebox position, determine a first position intensity distribution pattern of the optical image diffracted with respect to the first eyebox position;
determine a reference position intensity distribution pattern of the optical image diffracted with respect to a reference eyebox position; and
perform a first adjustment of the projected intensity distribution pattern based on the first position intensity distribution pattern and the reference position intensity distribution pattern so that the optical image diffracted with respect to the first eyebox position after the first adjustment has an intensity distribution pattern that matches the reference position intensity distribution pattern before the first adjustment.

2. The apparatus of claim 1, wherein the processor is further configured to: adjust the projected intensity distribution pattern by controlling a projector of the optical image based on the first position intensity distribution pattern and the reference position intensity distribution pattern.

3. The apparatus of claim 1, wherein the reference eyebox position is an eyebox center position.

4. The apparatus of claim 1, wherein the processor is further configured to:
receive a second eyebox position closer to an edge of the eyebox than the first eyebox position; and
in response to receiving the second eyebox position, perform a second adjustment of the projected intensity distribution pattern so that an average intensity of the optical image diffracted with respect to the second eyebox position after the second adjustment, is greater than an average intensity of the optical image diffracted with respect to the first eyebox position before the second adjustment.

5. The apparatus of claim 4, wherein a center of the optical image projected onto the hologram corresponds to a center of an array of spatial light modulators and an eyebox center position, wherein the processor is further configured to: in response to receiving the first eyebox position, perform shifting of the center of the optical image projected onto the hologram with respect to the center of the array of spatial light modulators so that after the shifting, the center of the optical image diffracted with respect to the first eyebox position corresponds to the first eyebox position.

6. The apparatus of claim 1, wherein the processor is further configured to:
determine a first intensity value of a dominant wavelength in a portion of the optical image diffracted with respect to the first eyebox position;
determine a second intensity value of the dominant wavelength in the portion of the optical image diffracted with respect to the reference eyebox position;
determine a gradient between the first intensity value and the second intensity value; and
perform a third adjustment of an intensity of the dominant wavelength in the optical image projected onto the hologram in accordance with the gradient so that the second intensity value of the dominant wavelength in the portion of the optical image diffracted with respect to the first eyebox position after the third adjustment, matches the first intensity value of the dominant wavelength in the portion of the optical image diffracted with respect to the reference eyebox position before the third adjustment.

7. The apparatus of claim 6, wherein the processor is further configured to adjust the intensity of the dominant wavelength in the optical image projected onto the hologram by controlling a projector of the optical image to adjust gain settings of a projector color control algorithm.

8. The apparatus of claim 1, wherein the processor is further configured to determine the first position intensity distribution pattern by:
providing a digital image defining the optical image projected onto the hologram and the received first eyebox position and to a hologram model; and
receiving from the hologram model a predicted first position intensity distribution pattern;
wherein performing the first adjustment of the projected intensity distribution pattern is based at least in part on the predicted first position intensity distribution pattern.

9. The apparatus of claim 8, wherein the processor is further configured to determine the reference position intensity distribution pattern by:
providing a digital image corresponding to the optical image projected onto the hologram and the received reference eyebox position to the hologram model;
receiving from the hologram model a predicted reference position intensity distribution pattern; and
adjusting the projected intensity distribution pattern based at least in part on the predicted reference position intensity distribution pattern.

10. The apparatus of claim 9, wherein the processor is further configured to adjust the projected intensity distribution pattern based on a difference between the predicted first position intensity distribution pattern and the predicted reference position intensity distribution pattern.

11. A method comprising:
receiving from an eye position sensor a first eyebox position within an eyebox defined by a hologram disposed in a window of a vehicle and illuminated by an optical image projected onto the hologram with a projected intensity distribution pattern;
in response to receiving the first eyebox position, determining a first position intensity distribution pattern of the optical image diffracted with respect to the first eyebox position;
determining a reference position intensity distribution pattern of the optical image diffracted with respect to a reference eyebox position; and
performing a first adjustment of the projected intensity distribution pattern based on the first position intensity distribution pattern and the reference position intensity distribution pattern so that the optical image diffracted with respect to the first eyebox position after the first adjustment has an intensity distribution pattern that matches the reference position intensity distribution pattern before the first adjustment.

12. The method of claim 11, further comprising: adjusting the projected intensity distribution pattern by controlling a projector of the optical image based on the first position intensity distribution pattern and the reference position intensity distribution pattern.

13. The method of claim 11, wherein the reference eyebox position is an eyebox center position.

14. The method of claim 11, further comprising:
receiving a second eyebox position closer to an edge of the eyebox than the first eyebox position; and
in response to receiving the second eyebox position, perform a second adjustment of the projected intensity distribution pattern so that an average intensity of the optical image diffracted with respect to the second eyebox position after the second adjustment, is greater than an average intensity of the optical image diffracted with respect to the first eyebox position before the second adjustment.

15. The method of claim 14, wherein a center of the optical image projected onto the hologram corresponds to a center of an array of spatial light modulators and an eyebox center position, wherein the method comprises: in response to receiving the first eyebox position, shifting the center of the optical image projected onto the hologram with respect to the center of the array of spatial light modulators so that after the shifting, the center of the optical image diffracted with respect to the first eyebox position corresponds to the first eyebox position.

16. The method of claim 11, further comprising:
determining a first intensity value of a dominant wavelength in a portion of the optical image diffracted with respect to the first eyebox position;
determining a second intensity value of the dominant wavelength in the portion of the optical image diffracted with respect to the reference eyebox position;
determine a gradient between the first intensity value and the second intensity value; and
performing a third adjustment of an intensity of the dominant wavelength in the optical image projected onto the hologram in accordance with the gradient so that the second intensity value of the dominant wavelength in the portion of the optical image diffracted with respect to the first eyebox position after the third adjustment, matches the first intensity value of the dominant wavelength in the portion of the optical image diffracted with respect to the reference eyebox position before the third adjustment.

17. The apparatus of claim 16, further comprising adjusting the intensity of the dominant wavelength in the optical image projected onto the hologram by controlling a projector of the optical image to adjust gain settings of a projector color control algorithm.

18. The method of claim 11, wherein determining the first position intensity distribution pattern is performed by:
providing a digital image defining the optical image projected onto the hologram and the received first eyebox position and to a hologram model;
receiving from the hologram model a predicted first position intensity distribution pattern;
wherein performing the first adjustment of the projected intensity distribution pattern is based at least in part on the predicted first position intensity distribution pattern.

19. The method of claim 18, wherein determining the reference position intensity distribution pattern is performed by:
providing a digital image corresponding to the optical image projected onto the hologram and the received reference eyebox position to the hologram model;
receiving from the hologram model a predicted reference position intensity distribution pattern; and
adjusting the projected intensity distribution pattern based at least in part on the predicted reference position intensity distribution pattern.

20. The method of claim 19, further comprising adjusting the projected intensity distribution pattern based on a difference between the predicted first position intensity distribution pattern and the predicted reference position intensity distribution pattern.
